(19) United States
(12) Patent Application Publication
(10) Pub. No.: US 2017/0027817 A1
(43) Pub. Date: Feb. 2, 2017

(54) CONVENIENCE KITS FOR TRANSPORTING AND ACCESSING MEDICAL VIALS

(71) Applicants: Gale H. Thorne, JR., Bountiful, UT (US); Kendall P. Thorne, Layton, UT (US)

(72) Inventors: Gale H. Thorne, JR., Bountiful, UT (US); Kendall P. Thorne, Layton, UT (US)

(73) Assignee: INTRAvENA, LLC, Bountiful, UT (US)

(21) Appl. No.: 14/813,569

(22) Filed: Jul. 30, 2015

(51) Int. Cl. A61J 1/16; A61J 1/20

(52) U.S. Cl. CPC A61J 1/16; A61J 1/20; A61J 1/2075

(57) ABSTRACT

This is an application for patent for convenience kits which comprise novel improvements over convenience kits disclosed in U.S. Pat. No. 8,449,521 titled METHODS FOR MAKING AND USING A VIAL SHIELDING CONVENIENCE KIT allowed May 28, 2013 ('521). Generally, convenience kits made according to '521 can be used to displace vials into a safety bag for spiking and dispensing fluids from the vials. Novelty for the current application is found in a provision for sealing and perpetually enclosing a vial within a bag and being able to spike and access fluid from the vial at any time thereafter.

This application is for novel convenience kits which are used for both transporting and accessing medical vials from a time when a vial is displaced into a safety enclosing bag, sealed within the bag and not further exposed to an exterior environment through vial and bag disposal. Some preferred parts for the convenience kits are disclosed in U.S. Pat. No. 8,449,521 titled METHODS FOR MAKING AND USING A VIAL SHIELDING CONVENIENCE KIT allowed May 28, 2013 (hereafter referenced as '521). While convenience kits made according to this invention utilize parts from '521, convenience kits, as fully disclosed hereafter, range of uses and effectiveness of resulting convenience kits are not evident from and are vastly improved over convenience kits disclosed in '521.

### FIELD OF INVENTION

Generally '521 relates to methods for making and using medical convenience kits and, more specifically, for making convenience kits which have a specific purpose of enclosing a vial to provide a closed system for transferring solutions from vials to IV dispensing systems used in patient drug delivery and especially for drug delivery using medicines which present a hazard when exposed to an open environment. However, methods and apparatus disclosed in '521 for cleaning of an inherently associated vial septum, prior to piercing, permit neither sufficient nor adequate time generally required to transport a capped and enclosed vial without access to (opening) bag contents to expose a wipe for sterilizing the septum prior to piercing. It is within the broader field of sealing, transporting, accessing and perpetually maintaining a medical vial within a closed system throughout a medical procedure and disposal that this present convenient kit finds application.

### BACKGROUND AND DESCRIPTION OF RELATED ART

Philosophically and practically, a medical device, such as that embodying Applicant's invention, to be truly useful in modern contemporary practice must not only be considered safe and efficient, but must also be cost effective. There are many facets of related devices which affect cost effectivity. Such facets include product costs relative to value of treatment made possible by the device, cost of inventorying (e.g. how many parts or stock keeping units (SKU's) are necessary to keep in stock to cover possible uses of the device), risks associated with device use and ability of device makers to meet manufacturing standards established for the safety of a receiving patient. It is for this reason that Applicants have elected to concentrate upon convenience kits assembled from products currently proved and certified as being safe and effective for medical use by manufacturers whose controls and procedures are also certified.

As an example, vial adapters are well known and widely available in contemporary medical commerce. Such vial adapters are available as vented and non-vented models and use of both types fall within the scope of the instant invention. Further, as vial adapters generally are not only used to provide access to vial contents by spiking a vial septum, but also to provide stabilizing flanges or latch arms which latch about cap and neck of a vial to securely affix the vial to the adapter. While such latch arms or stabilizing flanges have proved effective, vial adapters with such appendages must often be customized to meet different vial size requirements. This results in increases in numbers of SKU's required to meet needs of a variety of vial sizes used, increasing cost of handling and inventory. Such problems can be eliminated by finding a way to secure a vial to a vial adapter spike without requiring stabilizing flanges (or latch arms) thereby providing an opportunity to use a vial adapter that has universal application to a large range of vial sizes. Solution for such is disclosed hereafter.

### RELATED ART

U.S. Pat. No. 8,449,521 B2 ('521), as disclosed above, provides for enclosing and accessing a vial, but has a time limitation between time an associated vial is finally enclosed and when the vial septum can be effectively cleaned for spiking. It is this specific limitation which provides a need for newly devised kits for which this application is introduced.

U.S. Pat. No. 8,485,356 B2 ('356) is a continuation-in-part of '521 disclosing a method for accessing a vial septum swab before finally sealing a vial enclosing bag. [Underlining being for emphasis that the disclosed philosophy for vial enclosure was timely associated with swab exposure.] It is this philosophy which requires a completely different convenience kit, such as the instant invention disclosed herein, to meet more stringent vial enclosure requirements.

U.S. patent application Ser. No. 12/460,470, from which '521 continues-in-part, discloses problems associated with Hazardous Drug Handling and provides inventive solutions for those problems. This patent application incorporates by reference such disclosure and other information relative to specifying configurations for shrouding vials preparatory to drug transfer.

U.S. Pat. No. 7,758,560 B2 issued Jul. 20, 2010 to Edward G. Connell, et al. (“Connell”) and titled HAZARDOUS MATERIAL HANDLING SYSTEM AND METHOD discloses a method and system for handling hazardous materials contained in a vial. The system includes an isolation enclosure having an opening for selectively sealing about a vial; the enclosure being made up of a cap portion and a bag body portion. Inside the enclosure is an extraction member (vial adapter) having a preceding engaging member and a primary engaging member which include a plurality of latch arms for securing the vial to the extraction member in two separate steps taken before and after spiking the vial, respectively.

As seen in FIGS. 2 and 3 of Connell, enclosure 14 comprises a body portion 16 and a cap portion 17. Body portion 16 is taught to be a flexible bag which is affixed to cap portion 17 to form impermeable enclosure 14. Cap portion 17 is taught to be constructed of rigid material having an inlet port 18 and an outlet port 19. Inlet port 18 comprises a male connector for connecting to a connecting member 52 on the distal end of body portion 40 (a dispensing portion of a vial adapter). Outlet port 19 comprises a female connector for connecting to a valve component (e.g. needleless connector) 54. Ports 18 and 19 provide an exit pathway from enclosure 14. Clearly, ports 18 and 19, while providing an exit pathway, also add what is generally known as “dead space” by requiring an additional volume of liquid to be delivered from a vial to the valve component when compared to a simpler direct attachment between a vial adapter and an exit valve (needleless connector) which is commonly found in vial adapters securely affixed to needleless connectors in parts contemporarily commercially available.

The vial adapter of Connell, referenced as engaging member 34 is taught and claimed to have a plurality of latch arms for engaging a vial when first inserted into enclosure 14 at a first site which is distant from a vial spike such that closure of body portion 16; then, after bag closure, for engaging the vial at a second site whereat the vial is spiked. In this way, the following two things are apparently accomplished: (1) no emissions from spiking are possible until the bag is closed and (2) the vial spike is not inadvertently contaminated by contact with an unsterile vial exterior during vial insertion, a problem which must be solved by any closed vial adapter spiking process. The latching arms, themselves, apparently provide for stabilizing the vial inside an enclosure having a base made of a hard plastic shell.

Connell teaches both a non-vented vial adapter and a vented vial adapter. The valve affixed to outlet port 19 is commonly known as a CLAVE® needleless connector.

Connell further teaches a needleless connector adapter 62 which may be used with a syringe and to the CLAVE® valve to permit flow between the syringe and vial adapter, when attached, and restrict flow from each separated part when adapter 62 is separated from the CLAVE® valve.

U.S. Pat. No. 5,289,858 issued Mar. 1, 1994 to Rich W. Grabenkort (Grabenkort) and titled SYSTEM FOR ACCOMMODATING WITHDRAWAL OF LIQUID FROM A BULK SUPPLY discloses providing a safety enclosure for measuring and transferring liquid from a bulk container to a desired site of use or conveyance. The system is taught to be used with a highly commercially successful Add-Vantage® brand bulk drug reconstitution system sold in the United States. Mixing drug and diluent is taught to be accomplished within the bulk container, which provides a reservoir for the mixture in a bag 20. System 10, the subject of the titled invention, is connected with bag 20 through a connecting means 50 to a conduit 56. Conduit 56 is interrupted by a one-way valve 102 which prevents backflow into bag 20. A syringe is taught to be engaged in communication with conduit 56 through a “Y” connector 108 and a second connecting means 116 which is a valve that is closed when the syringe is separated therefrom.

The “Y” site is further connected to a conduit 132 which is also interrupted by a one-way valve. Conduit 132 is also interrupted by a stopcock 180 which may be switched to direct flow to a waste chamber 140 or to a drug receiving site. It is important to note that stopcock 180 is specifically provided for selection of a conduit to either direct flow from a syringe to a waste container or to the drug receiving site. It is also important to note that, due to the disposition of the one way valves, the syringe may be used as a pump to successively deliver liquid from bag 20 to a delivery site without rotating a pathway selecting member of stopcock 180. Stopcock 180 provides no valvular control of fluid flow between the source reservoir and the syringe during the pumping process.

Prevention of backflow by valve 102 provides the necessity for waste chamber 140, as excess liquid or air drawn into the syringe cannot be returned to bag 20. To provide for opportunity to deliver only a desired dose of liquid from the syringe, any excess fluid drawn into the syringe must be wasted. This is the reason for application of stopcock 180, to provide a selectable pathway to a waste chamber 140 because there is no return pathway to bag 20.

To provide access to bag 20 and other associated parts prior to drug transfer and to provide a flexible safety barrier an invertible bag 80 (i.e. one which may be in a given orientation to provide access to bag 20 and associated parts in one retracted state and extended (turned inside out) to envelop bag 20 and associated parts in another state) is taught and claimed. In this case, a vial 12 is connected to a bag 20 and no fluid is exchanged before bag 20 is inverted. Bag 20 is shown to be sealed about conduits 56 and 132 to provide a closed environment for bag 20 and associated parts once bag 80 is inverted and sealed superiorly. When inverted, the bag 80 is also taught to enclose waste receptacle 140. In FIGS. 6 and 7 of Grabenkort, it is shown that slider clamps may be used in place of the stopcock.

While Connell and Grabenkort both disclose systems and methods for enclosing a source of medication prior to access and delivery of such, problems of numbers of SKU's, fluid (i.e. drug) handling efficiency and development of specialized parts should be considered relative to novelty of Applicant's invention.

TABLE 1
Terms and Definitions

In the following table 1 is a list of terms and associated definitions provided to improve
clarity and understanding of precepts of the instant invention:
accessing, v, generally, when dealing with acquiring fluid from a vial, spiking the vial
septum for access to material within a medical vial
convenience kit, n, a medical device kit as defined by the United States FDA.
effluent, n: something that is emitted (flows out), particularly, from a vial.
enclose, v: when related to a bag enclosure, a sealed encasement
fluid, n: a gas or liquid.
flush syringe, n: a-syringe, pre-filled with a predetermined volume of flush solution.
HD, n: hazardous drug.
IV set, n: intravenous drug delivery tubing specifically dedicated for use with an
associated IV catheter and IV container.
IV container, n: a container, made of glass or plastic in the form of a bottle or IV bag used
to hold and deliver IV fluids containing medications for delivery through an IV.
kit, n: a group of parts, provided within a single package for a designated medical use
luer fitting, n: a medical connector which is in common use in medical practice.
luer locking connector, n: a connector associated with a luer fitting having a locking
mechanism whereby a male and female connector are securely, but generally releasibly
affixed one to the other.
needleless connector, n: a fitting which permits needle free fluid access to an IV set or
through a vial adapter and which has interface geometry similar to a conventional syringe
perpetual, adj, unceasing
port, n: a site for a medical connector, where through fluid is communicated.
shroud, n: a vial and vial adapter containing cover which provides a barrier against fluids
emitted from a vial septum during fluid acquisition from the vial.
SKU, n: stock keeping unit, an inventory term related to shelf quantities of a required
product.
subassembly, n: a part of an assembly.
subsystem, n: a part of a system
transporting, v, an action associated with vial conveyance which may require more time
than a swab can remain effective after being exposed for cleaning a vial septum
unitized, adj: a plurality of separate parts permanently joined to be used as a single unit.
vial, n: a medication container in which medication is delivered from a manufacturer to a
medical facility, fluid in the vial is usually accessed via a spike of a vial adapter which
pierces a septum of an exposed diaphragm of the vial.

### BRIEF SUMMARY AND OBJECTS OF THE INVENTION

In brief summary, this novel invention provides a basis for making and using vial adapter shrouding subsystems which are terminally sealed once a vial is disposed within an integrally associated shroud to provide a closed transfer system thereafter through disposal. Generally, the instant invention as disclosed herein, is a method or process for making and using a device embodied in convenience kit products. Such products are generally combinations of conventional, selected components which have been proved and certified for medical use.

The method for making and using a sealable vial adapter enclosing safety shield subassembly according to the instant invention generally involves the following:

### Selecting and Making Use of the Following Commercially Available Medically Certified Products

(a) as cited in '521, preferably, a vial adapter, which may be vented or non-vented, having a vial spike for piercing a vial septum on a proximal end and a fluid dispensing portion on the opposite or distal end and also having an installed removable cover for the vial spike. The vial adapter preferably is without a vial securing latch arms or vial attachment flanges, although adapters having such attachment arms may be used within the scope of the invention. As is true of substantially all vial adapters, the fluid dispensing portion is a hollow tube having internal geometry consistent with a female luer fitting and an exterior cylindrical surface distally ending at outwardly protruding flanges structured for mating with a male luer locking connector;

(b) a fluid valving device (such as a needleless connector or a male adapter plug), similar to such a device cited in '521, which has a male luer fitting and a luer locking connector which provides a luer locking interface for flanges and geometry of the female luer fitting of the associated vial adapter;

(c) as disclosed in '521, a hollow cylindrical elastic gasket or collar having an internal diameter which is sized to fit tightly about the outer surface of the vial adapter fluid dispensing portion when relaxed but having sufficient elasticity to be stretched without permanent deformation to be displaced over the flanges at the end of the dispensing portion. The gasket has proximal and distal edges defining a length which is less than the length of the cylindrical outer surface of the dispensing portion and a wall thickness which is sized to interact circumferentially with the male luer locking connector of the fluid valving device; and

(d) a conventional plastic bag which is sealable for perpetual bag closure at an otherwise open end of the bag is preferably employed for the shroud. In convenience kits made according to the instant invention, it is preferable for an associated vial to be introduced into the bag at a safety work site which is remote from a site of use. It should be noted that a bag, as used in '521, cannot be finally sealed until introduction of an exposed swab or until a swab is exposed (see U.S. Pat. No. 8,485,356 B2).

(e) providing a means (preferably a frangible cartridge) for saturating a swab to be used for swabbing (cleaning a vial septum) which can be actuated by manipulation of the exterior of the vial and vial adapter containing bag. It is this feature which sets the instant invention apart from the convenience kits of '521 and '356.

### Providing the Following Assembly Tools:

(f) as disclosed in '521, gasket or collar expanding and bag puncture tooling by which the gasket is elastically expanded to be displaced over the dispensing portion flanges (This tooling may comprise a tool having a cone shaped proximal end, a base of the cone being approximately the same diameter as the outward extension of the dispensing portion flanges with the associated point of the cone being blunted for assembler safety, yet sharp enough to pierce a hole in the plastic bag which is displaced over the flanges and about the dispensing portion. On the distal end, this tool preferably has a cylindrical rod portion which is sized and shaped to fit into the female luer orifice of the vial adapter.); and

(g) an assembly fixture upon which the vial adapter may be disposed during assembly, the fixture preferably having complementary slots and holes for stabilizing and releasibly mounting the vial adapter and a breadth and width sized to allow facile displacement of the bag there over.

### Then, Assembling the Subassembly, as Disclosed in '521, as Follows:

(h) affixing the swab cartridge to a vial adapter spike cover associated with the vial adapter;

(i) disposing the vial adapter with the swab cartridge affixed to the spike cover onto the assembly fixture oriented to provide access to the dispensing portion;

(j) inserting a portion of the gasket expanding tool into the female luer fitting of the dispensing portion of the vial adapter for use thereof;

(k) using the gasket expanding tool, elastically expand and displace the gasket over the flanges to thereby be disposed in a relaxed state in tight communication with the outer surface of the dispensing portion of the vial adapter at a site where the edge of the gasket closest to the flanges is sufficiently close to the flanges to communicate with a male luer connector later affixed to the flanges (It is preferred to apply adhesive to gasket and dispensing portion to securely affix the gasket to the dispensing portion; however; it is also preferred to use an adhesive which takes sufficient time to cure to permit connecting of an associated male luer connector before the adhesive sets);

(l) displacing the open end of the bag over the fixture such that the end of the bag opposite the open end communicates with the exposed point of the collar expanding tool;

(m) drawing the bag over the point to create a hole in the bag which is sufficiently large to permit the bag to be displaced over the flanges yet which is smaller than the diameter of the cylindrical outer surface of the gasket (It is important to note that when gasket and hole are disposed together, thickness of the gasket at the communicating edge of the gasket should entirely be in communication with the circumferential edge of the hole);

(n) displacing the collar expanding part from the dispensing portion;

(o) disposing the male luer fitting of the fluid valving device into the female luer fitting to make a secure fluid connection;

(p) securely affixing the connector of the male luer fitting in tight communication with the flanges on the dispensing portion, thereby forcing the gasket proximally against frictional forces to assure a sealing interface between luer locking connector, bag and gasket to ensure a seal about the connector and thereby provide a complete subassembly for a convenience kit;

(q) accumulating the subassembly and other parts required for a predetermined medically related procedure and packaging them into a convenience kit; and

(r) sterilizing the convenience kit, preferably using gamma radiation technology.

At this Point Use of Convenience Kits Made According to the Instant Invention Depart from '521 and '356 in Methods of Use and Areas of Application; Examples of which are as Follows:

(s) at a site where hazardous drug vials can be handled with safety, displacing a predetermined vial into the bag;

(t) sealing the bag (which shall be kept closed and sealed) through subassembly disposal;

(u) transporting the subassembly to a site where drug from the vial is to be accessed;

(v) manipulating the exterior of the bag to remove a cover from the septum of the vial;

(w) further manipulate the exterior of the bag to release and appropriately saturate a swab of the swab cartridge with cleaning solution;

(x) swabbing the vial septum; and

(y) spiking the vial to provide access to vial contents through the fluid valving device.

Selection of the type of fluid valve device provided with each convenience kit is dependent upon targeted kit application. Though other fluid valving devices may be used within the scope of the invention, a selected device may be a needleless connector or a male adapter plug. If a needleless connector is used, medical or pharmaceutical use of the device is substantially the same as that of a conventional vial adapter/needleless connector currently commercially available. A male adapter plug is applicable to Operating Room (OR) use.

### Modes of Using the Invention

Convenience kits are specifically designed for use in well defined areas of medical application. Convenient kits made according to the current invention have dramatically different modes and methods of use than those associated with '521. Stated otherwise, a kit made according to disclosure of '521 cannot be effectively used with safety in applications hereafter cited for the present invention.

It is important to note that the shroud, of either '521 and the present invention, provides protection from hazardous material which may be on the outside of the vial, for gas or aerosols emitted upon vial spiking or for leakage and spills due to vial septum or other container failure. However, in an OR application, for example, it is equally as critical that the exterior of the shroud be able to be disposed on a sterile field.

In such systems, to guard against contact with matter on the exterior of a contaminated vial, it is recommended that all actions relative to accessing and drawing fluids from a vial be performed within the safety of the sealed enclosure provided by the shroud. For a latch-arm free vial adapter, vial handling and accessing are quite independent of vial size and form of the valve affixed to the dispensing portion of the vial adapter.

### If a Needleless Connector is Affixed to the Vial Adapter, Steps for Using the Subassembly Comprise:

(1) Attaching a measurement syringe (and, as desired, a needleless [and preferably dripless] connector adapter) to the needleless connector;

(2) Drawing and measuring a desired dose sample into the syringe;

(3) Disconnecting the measurement syringe (and needleless connector adapter) from the needleless connector; and

(4) Transporting the dose filled syringe to a site of use. (Note that the above four steps are commonly used in contemporary medical-vial-acquisition devices.)

It is important to note that a disconnection of the assembly from the IV container must be made for delivery of the target IV container to a site of use. For this reason, a connecting device, such as a needleless connector adapter (e.g. a Texium® or Spiros®) or a flush syringe attachment may be provided at the end of the extension set where connection is made with the target IV container to provide safety when disconnecting thereat. A syringe affixed with a needleless connector adapter may be provided as part of a kit for further convenience.

A problem using a vented vial adapter occurs when, through improper use, a gas pathway which provides a conduit for pressure equalization between a volume internal to the vial and ambient conditions outside the vial becomes occluded with liquid. When such occurs, gas pressure cannot be relieved as venting is impeded. Such can result in sufficient pressure build-up within the vial to rupture the filter and release of liquid originally resident in the vial being spilled.

Accordingly, it is a primary object to provide methods for making and using vial adapter enclosing safety shield convenience kits.

It is an important object to utilize a conventional, commercially available vial adapter and other commercially available proved and medically certified components.

It is a primary object to provide a kit and method whereby a vial adapter can be securely and perpetually enclosed within a shroud for any period of time prior to removing a septum cover and spiking the vial to permit vial enclosure prior to transport to a site of use.

It is a critical object to provide a sealable enclosure for the vial adapter such that the vial adapter may be a vented vial adapter.

It is also an important object to provide methods for making and using vial adapter enclosing safety shield convenience kits which do not require vial attachment flanges or latch arms to thereby reduce SKU and kit cost and broaden opportunity for use of conventional vial adapters.

It is a principle object to provide a vial adapter enclosing safety shield convenience kit in which dispensing portions of the vial adapter are directly connected to a fluid communicating device, as is commonly the case for conventional vial adapter/needleless connector interfaces.

It is an object to provide a vial adapter enclosing safety shield convenience kit which utilizes a needleless connector as the fluid communicating device for pharmacy applications.

It is an object to provide a convenience kit which is effective in providing enclosed vial access within an operating room (OR) environment.

It is another object to provide a vial adapter enclosing safety shield convenience kit which utilizes a male adapter plug as the fluid communicating device for OR applications.

It is another principle object to provide a method for sealing a hole in a plastic bag disposed about a fluid dispensing portion of a vial adapter such that the bag, once closed at an entry portal for displacing a vial into the bag, provides a sealed, closed enclosure for safety in vial content access.

It is another important object to provide a method for using a conventional plastic bag as the shield in a vial adapter enclosing safety convenience kit.

It is yet another object to provide a vial adapter enclosing safety shield convenience kit which may be used to access fluid from a vial via a measurement syringe and deliver such fluid to an IV container without disconnecting the syringe from a communicating connection with the vial adapter enclosing safety shield.

It is a consequential object to utilize commercially approved medical parts within the vial adapter enclosing safety convenience kit to assure safety during use.

These and other objects and features of the present invention will be apparent from the detailed description taken with reference to accompanying drawings.

### BRIEF DESCRIPTION OF THE DRAWINGS

FIG. 1 is a perspective of a vented vial adapter which may be used as part of a convenience kit, an associated spike of the vial adapter being hidden by a cover.

FIG. 1A is a cross section of a vial adapter septum, frangible wipe ampule and applicator.

FIG. 1B is a perspective of the vented vial adapter of FIG. 1 with a frangible applicator, seen in cross section in FIG. 1A, affixed to the cover of the adapter

FIG. 1C is a perspective of a vented vial adapter similar to the adapter seen in FIG. 1, but further comprising a tethered vent plug.

FIG. 2 is a perspective of a gasket or collar disclosed in '521 and used in conjunction with a vial adapter, such as the vial adapter seen in FIG. 1, to provide closure and a seal about a hole in a bag.

FIG. 3 is an expander tool providing tooling, disclosed in '521, for use in displacing the gasket about a dispensing portion of the vial adapter and for making a hole in the bag.

FIG. 4 is an exploded perspective of an assembly fixture also disclosed in '521, a vial adapter (seen in FIG. 1), and a bag puncture and expander tool and a gasket (seen in FIG. 2) and also disclosed in '521.

FIG. 5 is a perspective of the assembly fixture, disclosed in '521, with the vial adapter (see FIG. 1) disposed therein, and with the gasket (see FIG. 2) displaced over the puncture and expander tool (see FIG. 3) to be disposed about a dispensing portion of the vial adapter. Also a tool, also disclosed in '521, for forcing the gasket over the puncture and expander tool is seen to be superiorly disposed above the assembly fixture and associated parts.

FIG. 6 is a perspective of a conventional plastic bag with a zipper closure and a hang hole.

FIG. 7 is a perspective of the apparatus seen in FIG. 5 with the bag seen in FIG. 6 displaced over the assembly fixture to have a hole perforated therein by the puncture and expander tool.

FIG. 8 is a perspective of the apparatus seen in FIG. 7 with the puncture and expander tool removed.

FIG. 9 is an exploded perspective of the apparatus seen in FIG. 8 and a needleless connector disposed for connection to the vial adapter as disclosed in '521.

FIG. 10 is a perspective of a completed subassembly of the parts seen in FIG. 9 as disclosed in '521.

FIG. 11 is a perspective of the completed subassembly seen in FIG. 10 removed from the assembly fixture and having a spike cover secured about the adapter spike and affixed to a frangible wipe applicator.

FIG. 12 is a perspective of a subassembly similar to the subassembly seen in FIG. 11, but with a male adapter plug affixed to the vial adapter rather than a needleless connector.

FIG. 13 is a segmented cross section of the vial adapter with spike cover removed as disclosed in '521, a portion of the bag, the gasket and a luer fitting associated with an attached valve device.

FIG. 14 is a schematic of parts which are provided in an exemplary OR convenience kit.

FIG. 15A is a perspective of a portion of the subassembly seen in FIG. 11 with the bag opened at a proximal end such that a vial may be displaced into the bag thereat.

FIG. 15B is a perspective of the subassembly seen in FIG. 15 wherein the bag is inverted, for non-hand contact displacement of the bag about a vial to avoid digital contact.

FIG. 15C is a perspective of the subassembly of FIG. 15B with vial fully inserted and bag closed and sealed with a vial cap about to be removed.

FIG. 15D is a perspective of the subassembly of FIG. 15C with the vial cap removed and swab applicator actuated for use in disinfecting the septum of the vial.

FIG. 15E is a perspective of the subassembly of FIG. 15D showing vial adapter spike cap and wipe applicator in position to be removed.

FIG. 15F is a perspective of the subassembly of FIG. 15E with vial cap and associated wipe applicator removed and the vial adapter spike disposed for spiking the vial septum.

FIG. 15G is a perspective of the subassembly of FIG. 15F with vial adapter spike fully inserted through vial septum.

FIG. 16 is a perspective of the subassembly seen in FIG. 15 with the bag tightly folded and held in place by a glue dot to secure and stabilize the vial relative to the vial adapter and spike to complete an operating assembly, the septum cap, vial spike cover and associated wipe applicator being in the bag, but hidden from view.

### DETAILED DESCRIPTION OF THE ILLUSTRATED EMBODIMENTS

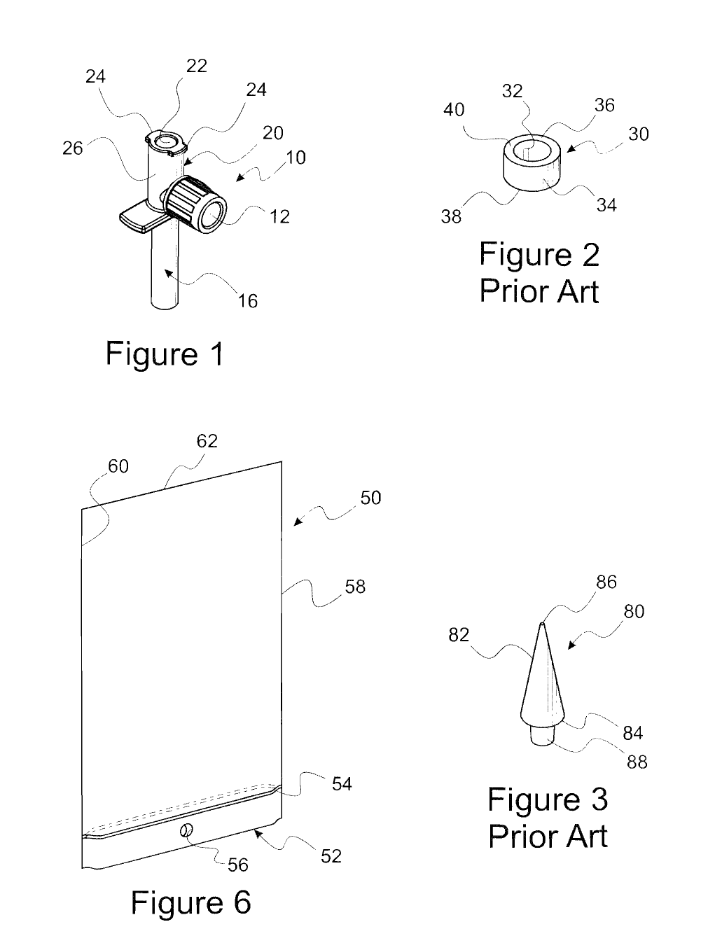

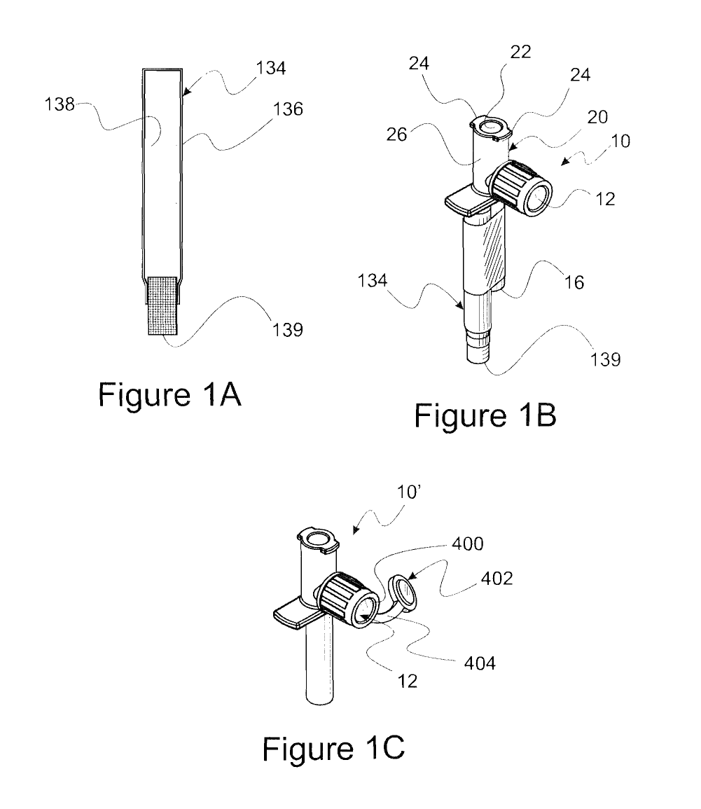

In this description, the term “proximal” generally indicates the segment of the device normally closest to the object of the sentence describing its position. The term distal refers to a segment oppositely disposed. Reference is now made to the embodiments illustrated in FIGS. 1-16 wherein like numerals are used to designate like parts throughout. FIGS. 3-5 and 7-10 and 13, identified as PRIOR ART, are replicates of similarly identified and numbered Figures of novel devices and associated methods disclosed in '521 and reprinted herein for completeness and ease of reference. For parts which are similar but not the same as parts originally specified with a given number, a prime of the original numbers is used. It is important that all parts selected for use in convenience kits associated with the instant invention, be able to be sterilized, for example, by such methods as gamma radiation. It is also important to note that each convenience kit is enclosed within a protective package for sterilization and transport. As such process are well known in the medical device art, packaging and methods of sterilization will not be further addressed herein.

### Methods of Assembly

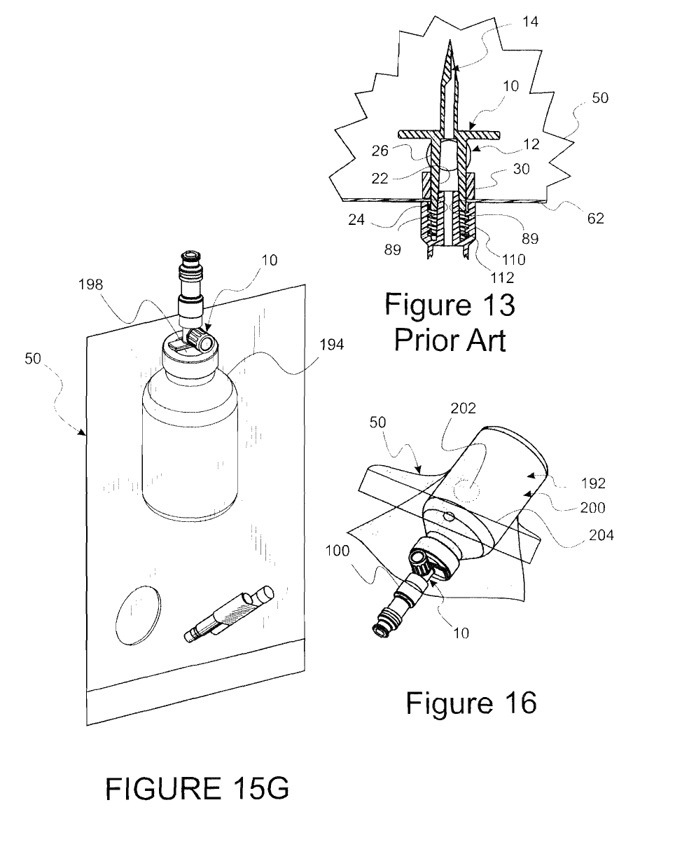

Reference is now made to FIG. 1 wherein an exemplary vial adapter 10 is seen. Vial adapter 10 is representative of many commercial vial adapters which may be used within the scope of the invention. Exemplary vial adapter 10 has an optional filtered vent 12 through which air is drawn (or emitted) to permit a gas exchange for fluids exchanged within an associated vial. (Other non-vented vial adapters may be used within the scope of this invention.) Also vial adapter 10 has a spike 14 (not seen in FIG. 1, but seen in FIG. 13). In FIG. 1, spike 14 is covered and protected by a removable cover 16 to provide for spike safety and protect sterility of spike 14 until time spike 14 is bared for the purpose of spiking a vial septum. It is critical that spike 14 be so covered initially, not only to protect sterility of spike 14, but also to obviate inadvertent piercing of sides of a shroud (e.g. a bag) in which vial adapter 10 is enclosed.

Vial adapter 10 also comprises a fluid dispensing portion 20 where through fluids are generally dispensed from a spiked vial. Portion 20 comprises a hollow tubular shape which extends distally to a female luer fitting 22 and associated connecting luer lock flanges 24. Proximal to flanges 24, portion 20 comprises a rounded surface 26 which is generally cylindrical in shape and of predetermined diameter. Exemplary vial adapter 10 may be a B/Braun mini-spike vial adapter product number S4003231 (or S4003400 if purchased before sterilization). It should be noted that most vial adapters have similarly configured dispensing portions.

Reference is now made to FIG. 2 in which a gasket or collar part 30 is seen. Gasket part 30 is a hollow cylindrical part which is defined by an internal surface 32 and an exterior surface 34. Length of part 30 is limited by a top edge 36 (as seen in FIG. 2) and a bottom edge 38. Both of such edges should be made smooth and even. A wall 40 has a thickness which is defined by the difference in diameter of surface 32 and surface 34. Gasket part 30 may be made by slicing a predetermined length of medical grade elastic tubing having an internal diameter which fits snugly about rounded surface 26 and a wall thickness which is greater than outwardly protruding length of flanges 24. Note that gasket part 30 must be sufficiently elastic to be stretched to be displaced over flanges 24 and sufficiently elastic to become snugly disposed about rounded surface 26 once disposed thereon. Material from which gasket part 30 may be made is medical grade extruded PVC (poly vinyl chloride) tubing.

A conventional zippered plastic bag, generally numbered 50, is seen in FIG. 6. While it is acceptable to use a zippered bag within the scope of this invention, any bag which is open only at one end and which is closeable and sealable to isolate bag contents from the surrounding environment may be used within the scope of the instant invention. If a bag heat sealer is available, it is preferred to use a standard, non-zip bag, for a more perpetual capture of a vial. It is of fundamental importance to note that a selected bag should not only be made of medically approved material, but also should be commercially available in sufficiently large commercial volume to assure a low manufacturing cost. Such a zipper closed bag may be a 4×8 inch, 2 mil bag, such as product number F20408H, 2 mil bag with hang hole from Discount Plastic Bags. A similar bag, but being made from 4 mil material may be acquired from GT Bag Company via part number G4ph4x8. Both Discount Plastic Bags and GT Bag Company may be contacted via the internet. Bag size may also be varied (e.g. a 5×8 4 mil hang hole zipper bag). The hang hole, though useful, is not needed for all convenience kit applications.

Referring again to FIG. 6, bag 50 has an open end 52 whereat, in this case a zipper seal 54 may be disposed to provide closure for bag 50 (for example only). Note that, a hole 56 which is disposed between end 52 and seal 54 is optional. Otherwise, bag 50 can considered to be closed along sides 58 and 60 and bottom 62. For this instant invention, it is preferable to heat or permaently seal (rather than zipper seal) the bag closed after a vial is disposed therein. It should be noted that convenience kits stemming from '521 cannot use such a heat seal prior to exposing a septum cleaning wipe for use.

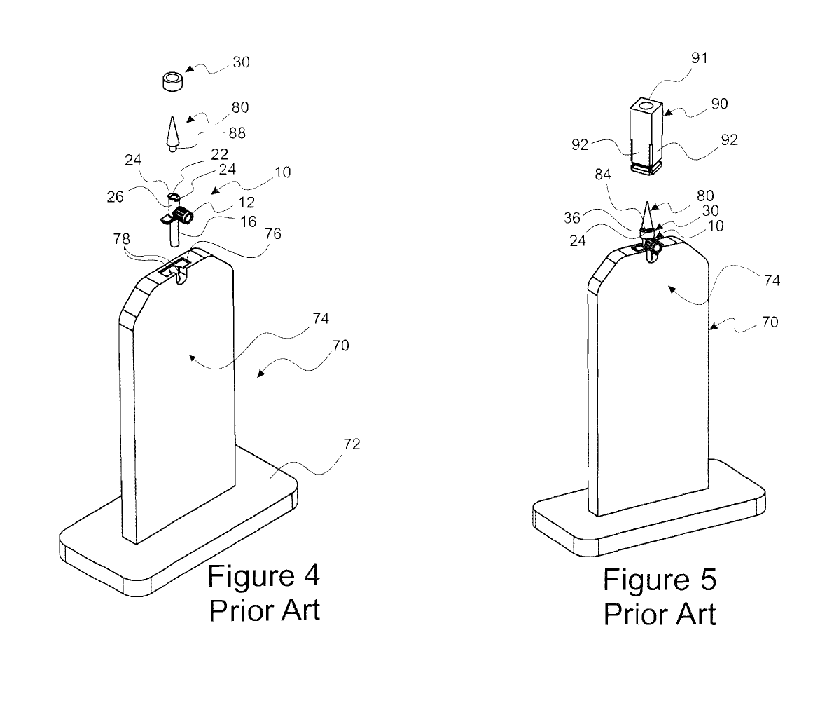

To provide stability for assembling common parts of a convenience kit according to '521 or of the instant invention, a stand 70, seen in FIG. 4, may be provided. Stand 70 has a stabilizing base 72 from which an upright assembly support 74 extends to a topmost section 76. Within section 76 a set of holes and groves 78 are provided which are complimentary to cover 16 and filtered vent 12 of vial adapter 10. Stand 70 may be made from any material which is sufficiently rigid to withstand assembly and which can be cleaned and used in a medical assembly environment.

One other part which is important in initial steps of an assembly of a convenience kit of the instant invention disclosed herein is a puncture and expander tool 80 seen in FIG. 3. As seen in FIG. 3, the upper portion 82 of tool 80 is cone shaped, extending upward from a base segment 84 to a point 86. In manufacture, point 86 should be blunted to obviate inadvertent injury to skin of a user. Extending downward from base segment 84 is a cylindrical rod 88 which has a diameter consistent with facile insertion into female luer fitting 22 of vial adapter 10. When disposed, as seen in FIG. 5, base segment 84 is broad enough in girth to expand a part, such as gasket 30 to be displaced over flanges 24 of vial adapter 10.

Referring once more to FIG. 4, assembly begins by inserting vial adapter 10 (i.e. cover 16) into complimentary holes and grooves 78 in stand 70. Rod 88 of puncture and expander tool 80 is next inserted into female luer fitting 22 of adapter 10. Gasket 30 is next disposed upon puncture and expander tool 80 and displaced over flanges 24 of adapter 10. A forcing tool 90, having a centrally disposed through hole 91 and displaceable legs 92 is seen in FIG. 5. Such a tool may be used to forcibly displace gasket 30 over flanges 24. Gasket 30 is seen so disposed in FIG. 5. It should be noted that gasket 30 should be disposed past flanges 24 just far enough to permit a male luer locking connector to engage flanges 24.

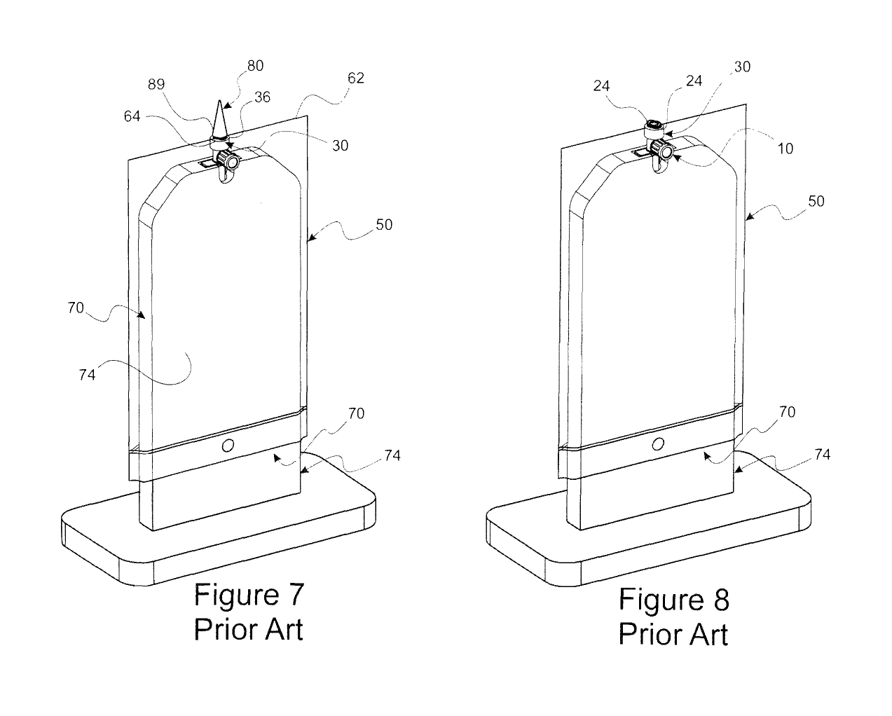

Next, a plastic bag (such as bag 50 seen in FIG. 6) is disposed about upright assembly support 74 of stand 70. Bag 50 is pulled downward until bottom 62 of bag 50 is punctured by puncture and expander tool 80 and until bottom 62 is in communication with gasket 30 creating a puncture hole 89, as seen in FIG. 7. Tool 80 is then removed, as seen in FIG. 8.

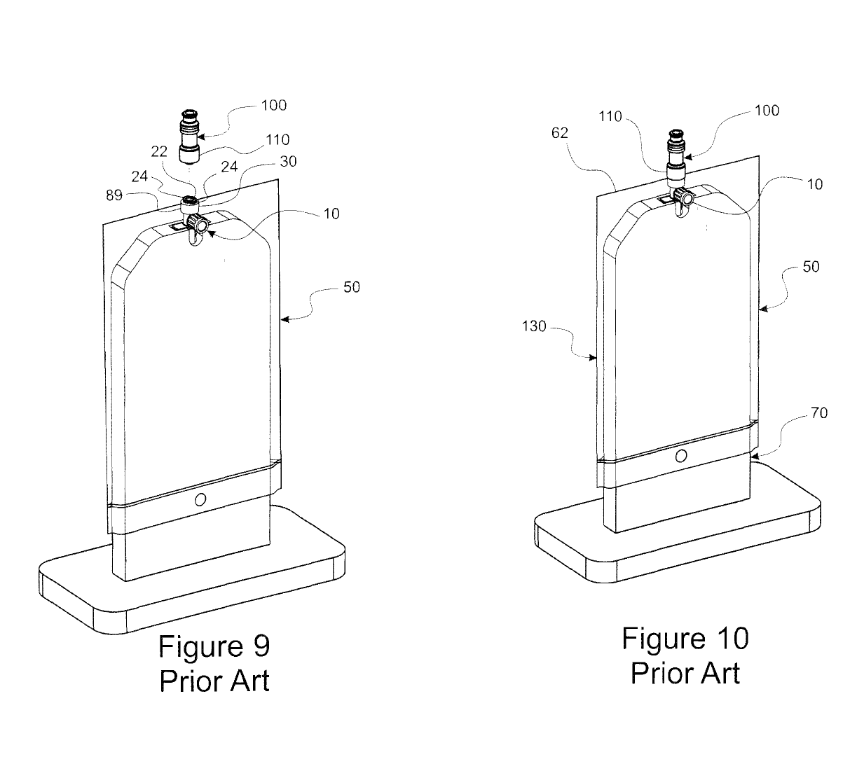

As seen in FIGS. 9-11, a fluid communicating device (such as needleless connector 100, seen in FIG. 9) having a luer locking connector 110 is then securely affixed to flanges 24 to complete subassembly 130. So connecting luer locking connector 110 to flanges 24 not only provides a selectively closed pathway for fluid dispensed from a vial, but also compressively communicates with bottom 62 of bag 50 and against gasket 30 such that a seal is made about hole 89 made in bag 50 by tool 80. It should be emphasized that novelty is derived from providing a sealed connection in cooperation between a male luer lock fitting and gasket 30 to provide a sealed access to bag 50.

Other connecting devices, other than needleless connector 100 can be used within the scope of the instant invention. In FIG. 12, a male adapter plug 300 is seen affixed to bag 50 and vial adapter 10 to provide fluid access via a self-sealing slit for either sharp or blunted canulas and included in subassembly 130′.

Formation of the seal about hole 89 in the bag is better seen in FIG. 13. Note gasket 30 is disposed about dispensing portion 26 of vial adapter 10 such that when luer locking part 110 is tightly secured to flanges 24 (after a male luer fitting 112 is appropriately engaged in female luer fitting 22). This securing compressively affixes bag bottom 62 about hole 89. It is preferred to addhesively affix both gasket 30 to dispensing portion 26 and luer locking connector 110 to flanges 24 to unitize parts of each associated convenience kit.

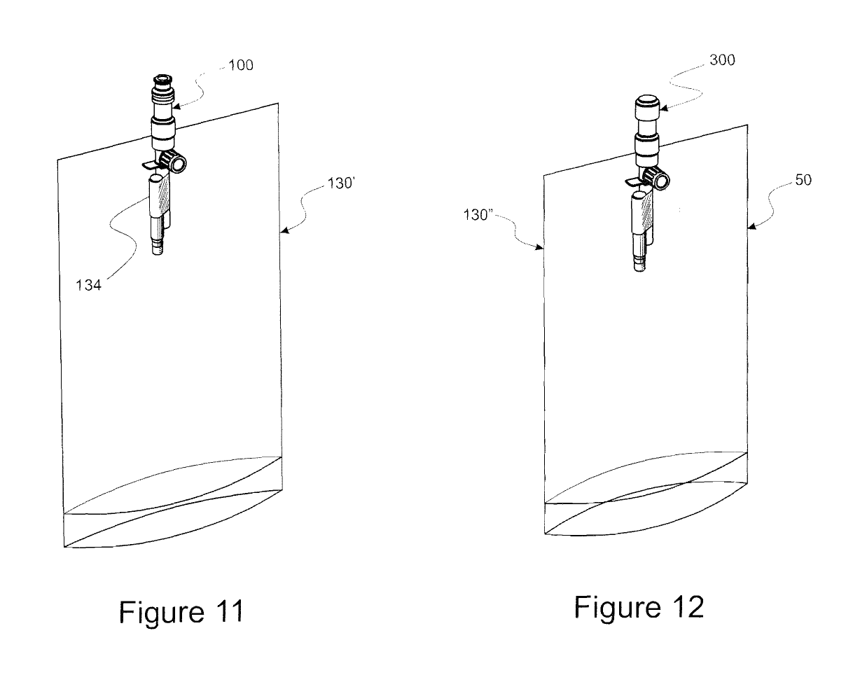

A completed subassembly 130′ with a needleless connector affixed to vial adapter 10 is seen in FIG. 10. In FIG. 11, subassembly 130′ is removed from stand 70 preparatory to packaging and final assembly of a convenience kit containing subassembly 130′. Further it should be noted that a frangible wipe ampule 134 is securely affixed to cover 16 which is releasibly affixed to cover 16 of vial adapter 10. Addition of wipe ampule 134 is a basic departure from '521 as it provides for actuation of a septum wiping process by action outside bag 50, as is disclosed in detail hereafter.

Reference is made to FIG. 1A wherein ampule 134 is seen in cross section. Ampule 134 is an example of a wipe which can be actuated (cleaning fluid released and made available through a porous wipe) by action through exterior skin of a plastic bag. Ampule 134 has a deformable exterior 136 made from flexible plastic which encloses a frangible capsule 138. Capsule 138 contains a cleaning fluid consistent with requirements to sterilize a septum of a vial. Capsule 138 is fragmented by exteriorly applied pressure to release fluid which saturates an exposed, porous wipe 139. Ampule 134 is preferably affixed to cover 16 to provide a handle for applying wipe 139 to a septum of a vial as seen in FIG. 1B. By providing such an exteriorly actuated ampule, a vial can be sealed within a bag at any time prior to vial spiking without requiring later access to the bag interior for actuating a vial septum wipe.

Being able to seal a vial within a bag and not requiring further access to the interior of the bag provides a significant opportunity not only in pharmacy applications, but also in providing closed system drug delivery in operating rooms. If exterior bag sterility is maintained as a vial is displaced therein, and the bag exterior is protected prior to use, an entire assembly can be deposited on a sterile field. Thus, via a convenience kit based upon the instant invention can house a vial with a contaminated exterior and be used to access a drug within the operating room environment whenever procedure requires.

### Methods of Use

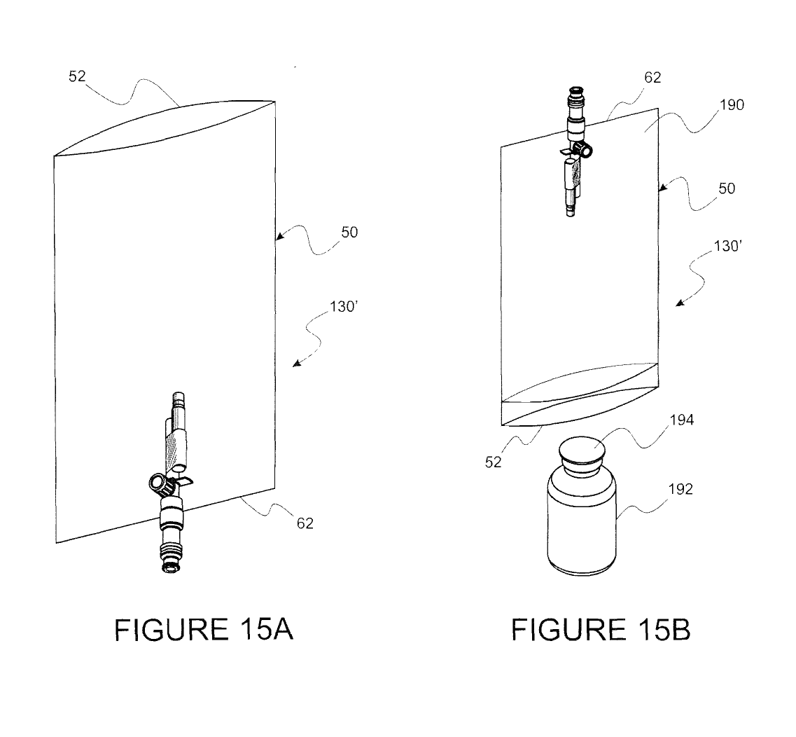

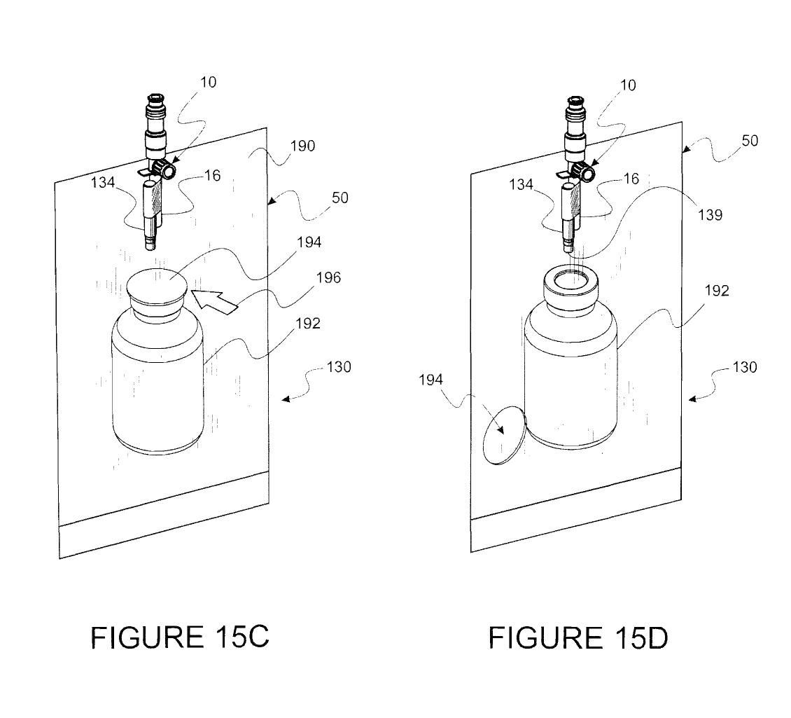

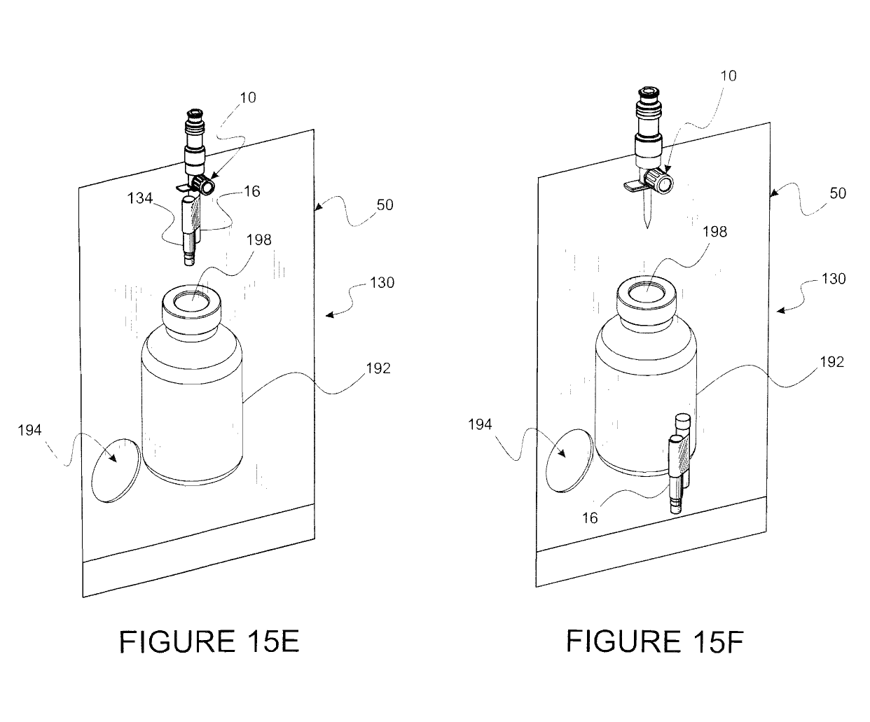

Referring to FIGS. 15A-15G, an exemplary subassembly 130′ is seen taken from a package where it was delivered as a sterilized product. As seen in FIG. 15A, end 52 (see FIG. 6) of bag 50 is opened before insertion of a vial into bag 50 with ampule 134 affixed to cover 16. Then, see FIG. 15B, bag 50 is opened to be disposed about a vial 192. Vial 192 is then preferably displaced without hand contact into bag 50 which is then sealed for perpetual enclosure of vial 192. It is recommended that the seal and closed state of the resulting package be tested by a slight squeeze to assure there is an adequate seal.

Note that vial 192 generally has a vial cap 194 (see FIG. 15B). If not removed before, vial cap 194 can be removed within bag 50 by applying finger pressure in direction of arrow 196, as seen in FIG. 15C. Once cap 194 is removed, digital pressure is applied to ampule 134 from outside the bag 50 exterior to fracture capsule 138 (see FIG. 1A) saturating swab 139 with cleaning fluid. Swab 139 is then used to cleanse the septum of vial 192 as seen in FIG. 15D. After cleansing the septum of vial 192, cover 16 (along with ampule 134) is removed from vial adapter 10 by telescoping bag 50 grabbing cover 16 through bag 50 and extending bag 50 to separate vial adapter 10 from cover 16, see FIGS. 15E and 15F. With cover 16 removed, the septum 198 of vial 192 is spiked as seen in FIG. 15G. Such an ampule is available from James Alexander Corporation, a United States of America company.

Because vial adapter 10 is without flanges or latch arms for stabilizing a vial, vial adapter 10 may be used with a large variety of vial sizes (independent of vial collar-top size). It is noted that flanges or latch arms are well known in vial handling art to provide support to stabilize a spiked vial. To provide a reasonable substitute for such support, bag 50 is tightly folded about the vial (such as vial 192) may use an elastic band 200 (earlier disclosed in '521). However, similar constraint can be accomplished using a glue dot 202, as seen in FIG. 16. By means of such binding, vial 192 is clearly stable for hand held operation and no vial supporting flanges or latch arms are required. In this configuration, needleless connector 100 may be affixed to a syringe (preferably through a needleless connector adapter) and a dose measured and transferred by procedures which are commonly used contemporarily. However, such is done with added safety due to complete enclosure of vial 192 by bag 50. Note also that vial 192 is perpetually contained within bag 50 by a preferred heat seal along line 204, rather than by a zippered closure.

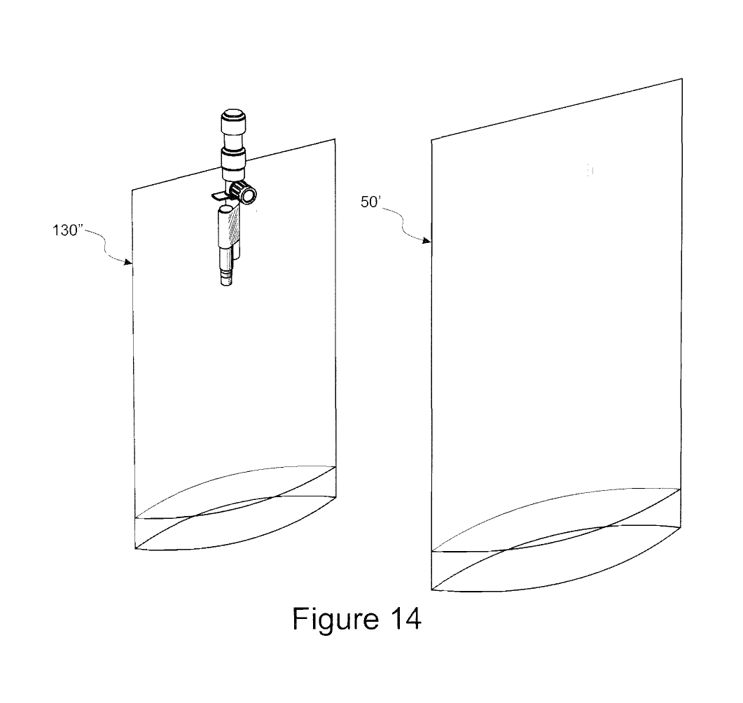

As seen in FIGS. 12 and 14, syringe needle access to contents of vial 192 can be made available via a male adapter plug 300, affixed via a luer lock fitting to vial adapter 10. It is common practice for such needles to be used in OR procedures. For effective use of the sterile exterior of bag 50 to be placed upon a sterile field in the OR, a second large bag 50′, seen in FIG. 14, may be used as a shroud for bag 50 and associated contents to pattern a convenience kit made according to the present invention for specific OR use. A male adapter plug for plug 300 is commercially available as Life Shield Short Prepierced Reseal Male Adapter Plugs with Luer Lock from Hospira, WORLDWIDE, Inc.

Reference is now made to FIG. 1C wherein a vented vial adapter 10′, similar to vial adapter 10 is seen. Vial adapter 10′ comprises a depressed opening 400 about vent 12 and a plug 402 affixed by a tether 404 to adapter 10′. In combination, tether 404 and plug 402 combine to provide a facile means for sealing vent 12 in case of a vent filter rupture. Such a vented vial adapter is available from Health Line International Corporation, Centerville, Utah,

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A convenience kit which provides a flexible, transparent bag for perpetually enclosing and therein spiking a vial which is displaced into the shield prior to being spiked, the bag not requiring further opening through medical procedure and disposal, said kit comprising:
a vial adapter having a vial spike for piercing a vial septum on one end and a fluid dispensing portion on the opposite end thereof, said fluid dispensing portion comprising a hollow cylindrical tube comprising internal geometry consistent with a female luer fitting and distally disposed outwardly protruding flanges structured for mating with a male luer locking connector and further comprising a cylindrical outer surface of predetermined length and diameter proximally disposed relative to said flanges;
a fluid communicating device comprising a male luer part which further comprises a luer locking connector and associated male luer fitting which provides a luer locking interface for flanges and geometry of said female luer fitting, said luer locking interface comprising a hollow cylindrical shape of predetermined radial diameter and linear length;
a hollow cylindrical elastic gasket having an internal diameter which is sized to fit tightly about said outer surface when relaxed but having sufficient elasticity to be stretched without permanent deformation to be displaced over said flanges, said gasket having proximal and distal edges which define a length which is less than the predetermined length of the cylindrical outer surface of the dispensing portion and a wall thickness which is sized to contact circumferentially said luer locking interface;
the flexible bag comprising a flexible exterior with a top opening which can be sealed closed to provide for complete bag closure at a vial introduction end and further comprising an otherwise closed bag including a bag bottom at an end opposite the top opening; and
said bag comprising a perforation which is sealed closed about the fluid dispensing portion of said vial adapter by complimentary, compressive displacement of said gasket and said male luer part to permit fluid flow only through said fluid dispensing portion; and
a vial septum cleaning fluid containment vessel comprising an outer compressible housing, a capsule disposed within said housing, a predetermined quantity of cleaning fluid disposed within the capsule and a porous wipe for communicating cleaning fluid to the vial septum;
said capsule further comprising wall structure which is fractured by pressure applied to the exterior of the bag and through said outer housing to release cleaning fluid which wets the wipe for cleaning the vial septum prior to spiking.

2. A convenience kit according to claim 1 assembled for Pharmacy applications comprising a needleless connector as the fluid communicating device.

3. A convenience kit according to claim 1 assembled for Operating Room applications comprising a male adapter plug as the fluid communicating device.

4. A convenience kit according to claim 1 wherein said cleaning fluid is alcohol.

5. A convenience kit according to claim 1 wherein said vial adapter is vented.

6. A convenience kit according to claim 1 wherein said male luer part is adhesively affixed to said vial adapter to unitize said luer part to said vial adapter.

7. A convenience kit according to claim 1 wherein said gasket is adhesively affixed to said vial adapter to unitize said gasket to said vial adapter.

8. A convenience kit according to claim 1 wherein said bag comprises a zipper seal for closing the open end after displacement of a vial into said bag.

9. A convenience kit according to claim 1 wherein said bag comprises a heat seal for closing the open end after displacement of a vial into said bag.

10. A convenience kit according to claim 1 wherein said vial adapter comprises a vent whereby gas pressure is relieved when fluid pressure is changed within an associated vial.

11. A convenience kit according to claim 10 wherein said vial adapter comprises a plug affixed thereto for obstructing fluid displacement through said vent.

12. A method for making a convenience kit sealable vial adapter enclosing safety shield convenience kit comprising the steps of:
(a) providing and assembling parts as follows:
(i) a vial adapter having a vial spike for piercing a vial septum on one end and a fluid dispensing portion on the opposite end thereof, said fluid dispensing portion comprising a hollow cylindrical tube comprising internal geometry consistent with a female luer fitting and distally disposed outwardly protruding flanges structured for mating with a male luer locking connector and further comprising a cylindrical outer surface of predetermined length and diameter proximally disposed relative to said flanges;
(ii) a fluid communicating device comprising a male luer part which further comprises a luer locking connector and associated male luer fitting which provides a luer locking interface for flanges and geometry of said female luer fitting, said luer locking interface comprising a hollow cylindrical shape of predetermined radial diameter;
(iii) a hollow cylindrical elastic gasket having an internal diameter which is sized to fit tightly about said outer surface when relaxed but having sufficient elasticity to be stretched without permanent deformation to be displaced over said flanges, said gasket having proximal and distal edges which define a length which is less than the predetermined length of the cylindrical outer surface of the dispensing portion and a wall thickness which is sized to contact circumferentially said luer locking interface;
(iv) a plastic bag comprising a top opening having a close-able seal which provides for complete bag closure at an otherwise open end of the bag and further comprising an otherwise closed bag including the bag bottom at an end opposite the top opening; and
(v) a bag puncture and gasket expander tool by which said gasket is elastically expanded to be displaced over the flanges to be disposed upon said cylindrical outer surface;
(vi) a vial septum cleaning fluid containment vessel comprising an outer compressible housing, a capsule disposed within said housing, a predetermined quantity of cleaning fluid disposed within the capsule and a porous wipe for communicating cleaning fluid to the vial septum; said capsule further comprising wall structure which is fractured by pressure applied to the exterior of the bag and through said outer housing to release cleaning fluid which wets the wipe for cleaning the vial septum prior to spiking.
(b) disposing said vial adapter such that access is permitted to the dispensing portion;
(c) disposing the puncture and expander tool in communication with the dispensing portion;
(d) forcibly displacing the gasket over said puncture and expander tool such that the gasket is elastically expanded and thereby displaced over the flanges of the dispensing portion to be thereby disposed in a relaxed state in tight communication with said outer surface such that the distal edge thereof is sufficiently close to the flanges to impedingly communicate with a the male luer locking connector when affixed to the flanges;
(e) creating a hole in the bag bottom which is sufficiently large to permit the bag to be displaced over the flanges yet which is smaller than the diameter of the cylindrical outer surface of the gasket such that, when gasket and hole are compressibly disposed together, the distal edge of the gasket entirely overlays the circumference of the hole;
(f) displacing said dispensing portion and associated flanges through the hole in the bag until the bag is in contact with the gasket;
(g) disposing the male luer fitting into the female luer fitting to make a secure fluid tight connection;
(h) securely affixing the luer locking connector in tight communication with the flanges thereby forcing the gasket proximally against frictional forces to assure a sealing interface between said luer locking connector, bag and gasket to ensure, after closing the seal of said bag and then spiking a vial with the vial spike, vial originated effluents, other than fluid delivered through luer fittings of said fluid dispensing portion, are fully contained within said bag; and
(i) disposing said fluid containment vessel within said bag as an integral part of said convenience kit in preparation for packaging for sterilization and delivery.

13. A method for making a sealable vial adapter safety shield according to claim 12 wherein the fluid communicating device providing step comprises providing a needleless connector which provides a valve for selectively permitting bidirectional fluid flow through said dispensing portion and of which the luer locking connector is an integral part.

14. A method for making a sealable vial adapter safety shield according to claim 12 wherein the gasket providing step comprises providing a gasket made from medical grade PVC tubing.

15. A method for making a sealable vial adapter safety shield according to claim 12 wherein said bag providing step comprises providing a bag with a zipper seal.

16. A method for making a sealable vial adapter safety shield according to claim 12 wherein the hole creating step comprises using said puncture and expander tool to puncture the bag bottom to provide the hole in the bag bottom.

17. A method for making a sealable vial adapter safety shield according to claim 12 wherein the gasket using step comprises applying adhesive to the dispensing portion outer surface at the site where the gasket is disposed to create a unitized structure between the gasket and dispensing portion.

18. A method for making a sealable vial adapter safety shield according to claim 12 wherein the luer locking connector affixing step comprises applying adhesive to securely affix the luer locking connector to the flanges, creating a unitized structure, thereby.

19. A convenience kit according to claim 12 wherein said vial adapter comprises a vented vial adapter having a closable vent with a filter for adapting pressure inside an associated vial and further comprising a step of closing said vent upon rupture of the filter.

20. A method for using a kit which comprises said safety shield made according to claim 12 in a medical procedure comprising the steps of:
(a) after gaining access to said bag from a transport package, displacing a medical vial into said bag through said top opening;
(b) sealing said bag;
(c) removing any previously unremoved septum protecting cap from the vial via exterior bag manipulation in preparation for spiking the vial;
(d) at any time after sealing the bag, fracturing the housing of the vial septum cleaning fluid containment vessel by applying pressure to the exterior of the bag to thereby wet the porous wipe preparatory to cleaning the vial septum; and
(e) spiking the vial for accessing contents thereof through the fluid communicating device.
